(19) United States
(12) Patent Application Publication
(10) Pub. No.: US 2007/0052129 A1
(43) Pub. Date: Mar. 8, 2007

(54) Embossed boards

(75) Inventors: Leonard Meredith, Maidstone (GB); Ian Crisp, Rochester (GB); Ken Fifield, Auckland (NZ)

Correspondence Address: BRADLEY N. RUBEN, PC, 463 FIRST ST, SUITE 5A, HOBOKEN, NJ, 07030, US

(73) Assignee: Celuform Limited

(21) Appl. No.: 11/355,363

(22) Filed: Feb. 16, 2006

(30) Foreign Application Priority Data
Sep. 6, 2005 (GB) 0518060.9

(51) Int. Cl. B29C 47/00

(52) U.S. Cl. 264/210.1; 264/284

(57) ABSTRACT

A method for forming an embossed extruded plastics molding which comprises the steps of extruding a plastics molding through a die to have a required profile, and passing the molding through an embossing press the embossing part of which is unheated, and operating a heater just ahead of the embossing part of the embossing press to flash heat a first (e.g. upper) surface/side of the extruded plastics molding, whereby the embossing part of the embossing press may press into and thereby emboss the previously heated surface.

### FIELD OF THE INVENTION

The present invention concerns improvements in and relating to embossed boards such as moulded plastics cladding boards used in the roofing industry. The invention provides an improved method and apparatus for forming embossed extrusions without warping and enabling fine embossing to be applied to extruded profiles.

### BACKGROUND TO THE INVENTION

Traditionally the fascia boards, barge boards and other cladding used around the roofs of buildings have been of wood that is painted or otherwise treated to optimise the preservation of the wood for an adequate working life and give an attractive appearance. Inherently, however, the wood does become progressively weather-beaten and rotten. Accordingly, more and more of late, extruded plastics cladding systems have gained favour for cladding roof ends and edges. These extruded plastics fascia boards and the like may be of a PVC-u foam core co-extruded with a skin of unfoamed PVC on one face to enhance strength and integrity and give an attractive external appearance to the board. Indeed, more recently we have developed such cladding boards where the PVC foam core is provided with a skin surrounding the board, being not simply on the upper face but also on the lower face of the board as is described in our co-pending UK Patent Application No: GB-2407793.

Whereas the extruded plastics cladding systems are functionally far superior to the painted wooden cladding of old, nevertheless the aesthetic of painted natural wood nonetheless remains desirable. Indeed, for period properties the property owners would generally naturally prefer to have cladding that is as close as possible in appearance to natural wood. With this in mind, a number of systems have been developed over recent years to give a wood grain effect to extruded plastics mouldings.

The most basic of these is a system that simply involves applying and adhering to the extrusion a foil which carries a graphic image of wood grain.

To provide an alternative and in some ways more satisfying aesthetic finish and one which is inherently more robust than a foil coated finish, it would be desirable to effectively emboss the surface of the extrusion to give contoured patterned wood grain finish. However, existing embossing systems as used in embossing wallpaper, fabrics and floor tiles and the like, generally all involve the use of a hot oil filled embossing roller or similar to emboss the pattern on the product. We have found that use of such heated rollers for pattern-embossing extruded plastics products as used in the roofing industry or similar is not generally viable since the process can compromise the original extruded shape of the boards and generally does not allow for fine detailed embossing.

It is a general objective of the present invention to provide a method and system for forming embossed extruded plastics mouldings such as, for example, cladding boards for roofs, which seek to overcome the aforementioned problems of the art.

### SUMMARY OF THE INVENTION

According to a first aspect of the present invention there is provided a method for forming an embossed extruded plastics moulding which comprises the steps of:
a) extruding a plastics molding through a die to have a required profile and, suitably, cooling the molding; and
b) passing the molding through an embossing press the embossing part of which is unheated, and preferably is cooled, and operating a heater just ahead of the embossing part of the embossing press to flash heat a first, e.g. upper, surface/side of the extruded plastics molding whereby the comparatively cold embossing press may press into and thereby emboss the heated surface

Thus, for example, unlike prior embossing systems that generally all use a heated embossing roller, the method and apparatus of the present invention uses a cooled embossing part (e.g. embossing roller) of an embossing press and instead it flash heats the surface of the extrusion just before it passes into the nip of the cool/cooled embossing part. This allows for fine detail embossing of a profiled extruded plastics board without distorting the profile of the board.

Preferably the heater is a convection heater, suitably being a blower of heated air such as, for example, a Leister™ heater.

Preferably the heater is located within about 10 mm (e.g. 5 mm to 50 mm) from the first surface and preferably a similar distance from the embossing part of the embossing press. In the context of a convection heater, the spacing is the spacing of a heated fluid (air) outlet nozzle of the heater from the leading edge of the embossing part of the press.

In most cases the embossing press comprises an embossing part that is an embossing roller and which presses down onto the extrusion as supported by a support element, suitably support roller, on the other side of the extrusion. The support element/support roller preferably is shaped to the profile of the corresponding surface of the extrusion that it contacts in order to provide optimal support to the extrusion and further mitigate against any risk of change in profile of the extrusion.

Preferably the heating is applied through a heater that heats via a nozzle or other heat delivery component that substantially spans the width of the part of the extrusion to be embossed to deliver the heat substantially evenly across the width of the extrusion part to be embossed.

To further protect against unintentional alteration of the overall form of the extrusion by the embossing process the embossed extrusion is suitably heated on the said other side of the extrusion prior to, while or shortly after leaving the embossing press. This heating of the other side is suitably the same or closely similar in magnitude and heat delivery configuration to the heating of the first side/surface to balance any relative heat expansion of one side of the extrusion relative to the other. By ‘same configuration’ we mean same in so far as if the heat delivery part/head of the heater before the embossing press spans the width of the extrusion then so too does the heat delivery part of the heater at the exit of the embossing press.

The heating of the embossed extrusion suitably ‘steers’ the extrusion to continue in a straight level line substantially unaltered relative to its form and path on exiting the extruder. In one embodiment a first convection heater head spans the width of the extrusion with a ‘fishtail’ nozzle to stabilize the extrusion and prevent twisting while a second heater head without a fishtail nozzle but rather a broad bore outlet directs heating fluid more centrally (i.e. more toward the median line of the extrusion) at the extrusion to help straighten the extrusion.

Suitably the heating is applied to locally heat the surface to a temperature of the order of 65 to 100, and preferably 70, degrees Celsius. By contrast, the embossing part (embossing roller) of the embossing press is suitably cooled/chilled, e.g. by cold fluid such as water ducted through or suitably over the embossing part, to a temperature of the order of 5 to 15, and preferably 10 to 12, degrees Celsius. The embossing press thus immediately begins to quench the plasticization of the surface of the extrusion being embossed, giving unprecedented control over the precision of embossing and mitigating against distortion of the profile of the extruded board that otherwise occurs.

According to a second aspect of the present invention there is provided an apparatus for embossing an extruded plastics molding which comprises:
a) a frame carrying an unheated embossing roller and having an opposing support to support the extruded plastics molding passing through the apparatus, the embossing roller and support being movable together and apart; and
b) a heater positioned just ahead of the embossing roller to flash heat a first, e.g. upper, surface/side of the extruded plastics molding whereby the embossing roller may press into and thereby emboss the heated surface and the surface is cooled as it comes into contact with the unheated embossing roller.

### BRIEF DESCRIPTION OF THE DRAWINGS

A preferred embodiment of the present invention will now be more particularly described, by way of example, with reference to the accompany drawings, wherein:

FIG. 1 is a schematic general assembly diagram of an extrusion production line for extruded plastics cladding boards;

FIG. 2 is a side elevation view of an embossing apparatus of the preferred embodiment of the present invention that is adapted to fit to the extrusion line, suitably between the sizing unit exit of the extruder and the haul-off equipment;

FIG. 3 is a rear (i.e. from downstream) top perspective view of the embossing apparatus;

FIG. 4 is a rear perspective view similar to FIG. 3 but from below; and

FIG. 5 is a frontal perspective view of the apparatus.

### DESCRIPTION OF THE PREFERRED EMBODIMENT

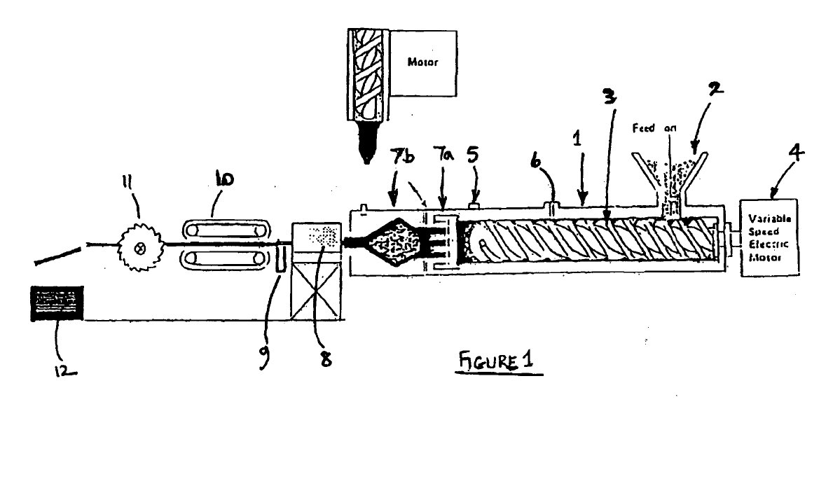

Referring firstly to FIG. 1, this shows a substantially conventional production line for forming extruded plastics cladding boards as used for roofing. The extruder 1 has an infeed hopper 2 to receive the plastics material to be extruded and which, within the body of the extruder 1, is heated by heating coils in the wall of the extruder 1 body while being compressed and driven forward to the outlet end of the extruder 1 by drive screw 3 within the extruder 1 body and which is powered by variable speed electric motor 4.

The temperature within the body of extruder 1 is monitored via thermocouple 5 and a vent 6 in the body of the extruder 1 vents air from within the body of extruder 1. A breaker plate 7a at the outlet end of the extruder body 1 ensures a homogeneous flow of compressed molten plastics out through die adapter and die section 7b and thence into sizing unit 8 where the single or dual skinned extrusion is formed to the required board profile dimensions.

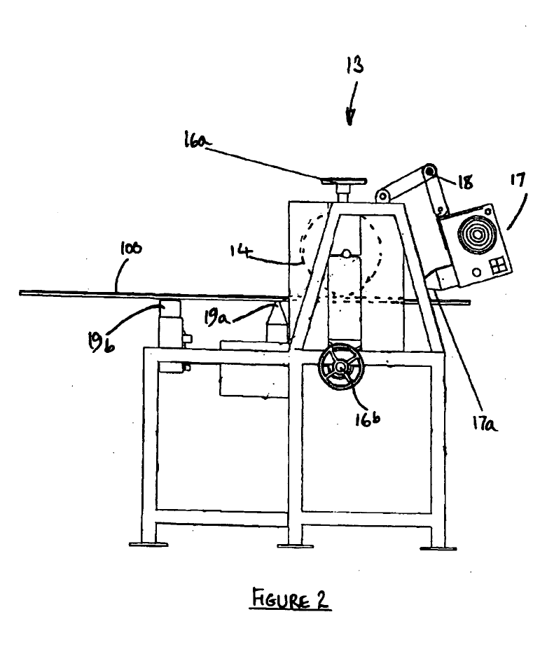

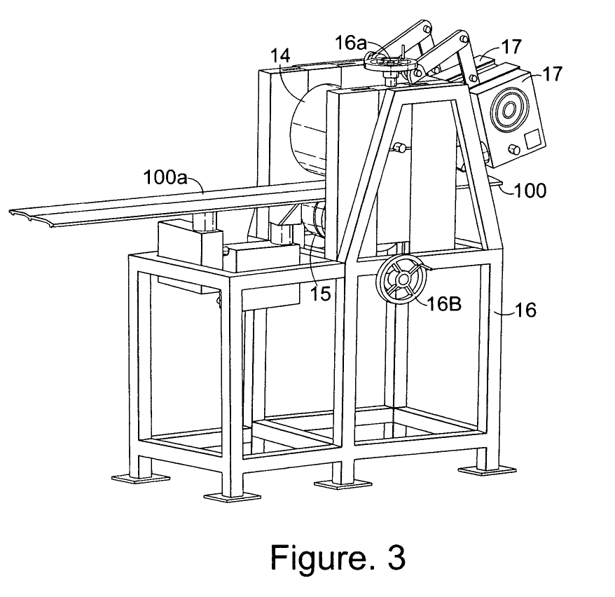

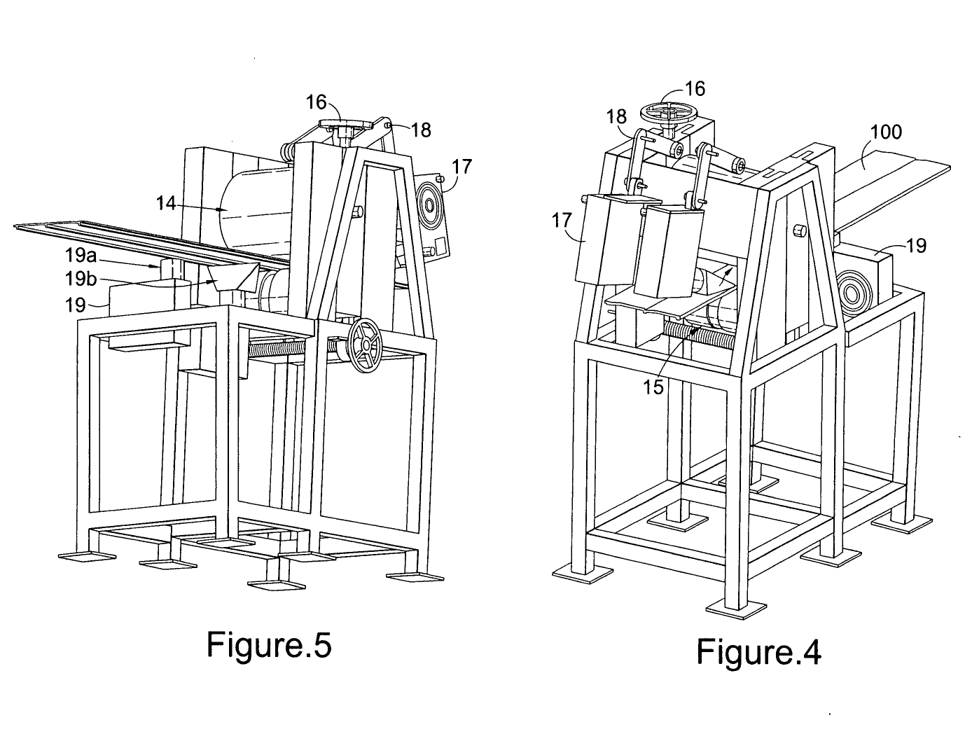

In the preferred example the board is extruded horizontally, molded as a sandwich of a PVC-ue (i.e. expanded PVC) core enveloped between upper and lower face skins of PVC-u, or with a skin of PVC-u only on one face, and with a profile that has ridges/channels running lengthwise of the board on the upper and/or lower faces to resemble, for example, a shiplap or double shiplap board appearance. One important feature of the embossing system of the present invention is that it preserves this profiled appearance of the profiled faces when embossing details into the upper/outer in use face as will be described shortly with respect to FIGS. 2 to 5 of the accompanying drawings.

Once the extrusion has exited the sizing unit 8 it is rapidly cooled to set rigid by immersion in a water bath of cold/chilled water at primary cooling unit 9 just beyond the extruder exit and is then dried by a jet of air. Downstream of this the extrusion is hauled away by haul off equipment 10 prior to being cut to required lengths by a suitable saw/cutter 11, whereafter it is collected and stacked 12.

Turning now to FIGS. 2 to 5, the embossing facility 13 of the present invention fits into the production line of FIG. 1 between the exit of the sizing unit 8 and the entry of the haul off equipment 10, being about 2 m or so downstream of the primary product cooling unit 9.

The embossing facility 13 is an embossing press that has an upper embossing roller 14, suitably of the order of 480 mm diameter, formed with embossing surface contours to represent woodgrain or other desired embossed effect, which bears down onto the upper face 100a of the extruded board 100 to press into and emboss that face 100a, the board being supported from below by a support roller 15 vertically opposed to the embossing roller 14. Support roller 15 has a profile (here double shiplap style) that is matched to the profile of the underside 100b of the extruded board 100 to provide optimal uniform support to the board and help maintain the extruded shape of the board 100.

The embossing roller 14 and support roller 15 are held within a framework 16 that has a crank shaft arrangement 16a that allows for adjustment of separation between the rollers 14, 15, i.e. here allows for the upper, embossing, roller 14 to be moved upwardly and downwardly relative to the board 100 supported on support roller 15 to control the engagement, disengagement and depth/pressing force of the embossing process.

The framework 16 of the embossing press also has a crank shaft arrangement 16b that allows for lateral adjustment of the support roller 15 relative to the embossing roller 14 within the framework 16. In other words the support roller 15 can move somewhat (e.g. up to about 300 mm) from side to side relative to the longitudinal axis of the production line in order to fine tune alignment therewith or to serve as a means of finely adjusting the position of the embossed pattern if required.

At its upstream end the framework 16 of the press carries a heater arrangement 17 configured to direct heated air onto the upper face 100a of the extruded board 100 just ahead of the nip between the embossing roller 14 and support roller 15. For heating the two parallel planar surfaces of the double shiplap profile upper side 100a of the board heater arrangement 17 suitably comprises a parallel pair of 3.7 kW Leister™ heaters each with a respective fishtail nozzle 17a,17b that is thin in the direction of the production line but spans the width of the respective planar surface (e.g. 150-170 mm wide exit to each nozzle to correspond to each of the two 150-170 mm wide planar surfaces on upper side of board 100 that are to be embossed). The nozzles 17a and 17b are held by an adjustable gantry arm 18 to be adjustably positioned so that their exits are about 10 mm from the pinch of the rollers 14, 15 and also about 10 mm from the surface 100a of the extruded board.

The heaters 17 supply air that exits the nozzles 17a, 17b at a temperature of about 250 to 280 degrees Celsius to serve in use to instantly heat the planar faces of the upper surface 100a of the board to about 70 degrees Celsius sufficient to plasticize just the surface 100a for embossing by the embossing roller 14. The application of the heat can be described as flash heating since the heat is applied instantaneously to the board surface 100a just before it is embossed and the temperature of the surface 100a directly cooled by the embossing roller 14. The heat has no time to penetrate deep enough into the board 100 to cause significant distortion to the profile and shape of the board.

The embossing roller 14 is cooled to about 10 degrees to 12 degrees Celsius by a supply of chilled water that streams over the outside of the roller 14 or, more preferably, that is ducted through the interior of the roller 14 via a coiled heat exchange duct and enters and exits via the spindle shaft of the roller 14.

Just at the exit of the embossing press the framework 16 carries a further set of convection heaters 19, the purpose of which is to reheat the extruded board 100 at the underside 100b to counterbalance any bowing of the board that may have occurred as a result of the heating and pressing by the embossing press and to steer the board 100 straight. A first convection heater head 19a spans the width of the extrusion with a ‘fishtail’ nozzle to stabilize the extrusion and prevent twisting while a second heater head 19b without a fishtail nozzle but rather a broad bore outlet directs hot air more centrally (i.e. more toward the median line of the extrusion) at the extrusion to help straighten the extrusion.

Example Operational procedure

Preliminary checks should firstly be carried out to check the machine operation and adjustments including checking that guarding is in place and secure, checking heater settings and thermocouples, checking top 14 and bottom 15 rollers for free rotary movement and top roller 14 for upward and downward adjustment, all before starting the embossing process.

Next the extruding machine 1 is started up and run to begin extruding to a satisfactory standard. When pulling through the extruded profile 100 the top roller 14 is adjusted well away from the profile 100 to ensure a clean pull through.

The profile 100 should run on the bottom roller 15 and the extruder should be operated to give a flat—in specification product. It should be ensured that the blowers that dry the water cooled extrusion exiting primary product cooling unit 9 are operational. The bottom roller 15 should be adjusted laterally into alignment with the extruded product 100 using the crank shaft 16b and the product should fit exactly to the bottom roller 15.

Once product is running to specification the top roller 14 is adjusted down until it just touches the profile 100 but not forced down to its embossing position yet. The Leister heater 17, 19 settings should be checked and they should then be switched on and the top roller 14 then lowered carefully until an initial light print is achieved. The machine is let to run 10 meters of product and the top roller 14 lowered further to give a more in-depth print. Once the roller 14 is producing a deeper embossed product the machine setting is corrected and print is checked.

To shut down the embossing facility the top roller 14 is first moved upwards away from the product 100 and the Leister heaters 17, 19 are then turned off.

What is claimed is:

1. A method for forming an embossed extruded plastics molding which comprises the steps of:
a) forming a plastics molding by extruding through a die to have a required profile; and
b) passing the molding through an embossing press the embossing part of which is unheated and operating a heater just ahead of the embossing part of the embossing press to flash heat a first, e.g. upper, surface/side of the extruded plastics molding whereby the embossing part of the embossing press may press into and thereby emboss the heated surface.

2. A method as claimed in claim 1, wherein the heater is a convection heater.

3. A method as claimed in claim 1, wherein the heater is located within about 5 mm to about 50 mm from the first surface and within about 5 mm to about 50 mm from the embossing part of the embossing press.

4. A method as claimed in claim 1, wherein the embossing part of the embossing press is cooled.

5. A method as claimed in claim 1, wherein the embossing press comprises an embossing part that is an embossing roller and which presses down onto the extrusion as supported by a support element on the other side of the extrusion.

6. A method as claimed in claim 4, wherein the support element/support roller is shaped to suit the non-planar profile of the corresponding surface of the extrusion that it contacts in use.

7. A method as claimed in claim 1, wherein the heating is applied through a heater that heats via a nozzle or other heat delivery head that substantially spans the width of the part of the extrusion to be embossed to deliver the heat substantially evenly thereacross.

8. A method as claimed in claim 1, wherein the embossed extrusion is heated on the other side of the extrusion to the embossed surface/side prior to, while or shortly after leaving the embossing press.

9. A method as claimed in claim 7, wherein the heating of the other side is the same or closely similar in magnitude and heat delivery configuration to the heating of the first side/surface to balance any relative heat expansion of one side of the extrusion relative to the other.

10. A method as claimed in claim 7, wherein the heating of the embossed extrusion ‘steers’ the extrusion to continue in a straight level line substantially unaltered relative to its form and path on exiting the extruder.

11. A method as claimed in claim 8, wherein the heating of the other side uses a first convection heater head which spans the width of the extrusion with a ‘fishtail’ nozzle while a second heater head without a fishtail nozzle but rather a broad bore outlet directs heating fluid more centrally at the extrusion.

12. A method as claimed in claim 1, wherein the heating is applied to locally heat the surface to a temperature of the order of 65 to 100 degrees Celsius.

13. A method as claimed in claim 1, wherein the embossing part (embossing roller) of the embossing press is cooled to a temperature of the order of 5 to 15, and preferably 10 to 12, degrees Celsius.

14. A method as claimed in claim 1, wherein the extrusion is a profiled board.

15. An embossed profiled board formed by the process of claim 10.

16. An apparatus for embossing an extruded plastics molding which comprises:
a) a frame carrying an unheated embossing roller and having an opposing support to support the extruded plastics molding passing through the apparatus, the embossing roller and support being movable together and apart; and
b) a heater positioned just ahead of the embossing roller to flash heat a first, e.g. upper, surface/side of the extruded plastics molding whereby the embossing roller may press into and thereby emboss the heated surface and the surface is cooled as it comes into contact with the unheated embossing roller

17. An apparatus for embossing an extruded plastics molding as claimed in claim 15, wherein the embossing roller is cooled in use.

18. An apparatus for embossing an extruded plastics molding as claimed in claim 15, wherein the apparatus further comprises a heater to heat on the other side of the extrusion to the embossed surface/side prior to, while or shortly after leaving the embossing press.
